(19) United States
(12) Patent Application Publication
(10) Pub. No.: US 2010/0307221 A1
(43) Pub. Date: Dec. 9, 2010

(54) Belt measurement device

(76) Inventors: Benjamin Morgan Smith, Golden, CO (US); David S. Miller, Highlands Ranch, CO (US); Imtiaz Ali, Lathrup Village, MI (US); Douglas G. Gerring, Hartland, MI (US)

Correspondence Address: THE GATES CORPORATION, IP LAW DEPT. 10-A3, 1551 WEWATTA STREET, DENVER, CO, 80202, US

(21) Appl. No.: 12/455,711

(22) Filed: Jun. 5, 2009

(51) Int. Cl. G01N 3/56

(52) U.S. Cl. 73/7

(57) ABSTRACT

A belt measurement device comprising a first portion and a second portion, the first and second portion are substantially parallel, the first portion and second portion defining a predetermined engagement position for the device in a belt, and, a switch cooperatively disposed with the first portion and second portion, the switch capable of closing a circuit by being compressed between a belt surface and the device, a light is illuminated upon the switch closing the circuit.

### FIELD OF THE INVENTION

The invention relates to a belt wear measurement device, and more particularly, to a belt wear measurement device comprising a second member for detecting a datum surface when a first member is engaged with an article feature.

### BACKGROUND OF THE INVENTION

What is needed is a belt measurement device comprising a second member for detecting a datum surface when a first member is engaged with an article feature. The present invention meets this need.

### SUMMARY OF THE INVENTION

The primary aspect of the invention is a belt measurement device comprising a first rib and a second rib, the first and second rib are substantially parallel, the first rib and second rib defining a predetermined engagement position for the device in a belt, and, a switch cooperatively disposed with the first rib and second rib, the switch capable of closing a circuit by being compressed between a belt surface and the device, a light is illuminated upon the switch closing the circuit.

Other aspects of the invention will be pointed out or made obvious by the following description of the invention and the accompanying drawings.

The invention comprises a belt measurement device comprising a first rib and a second rib, the first and second rib are substantially parallel, the first rib and second rib defining a predetermined engagement position for the device in a belt, and, a switch cooperatively disposed with the first rib and second rib, the switch capable of closing a circuit by being compressed between a belt surface and the device, a light is illuminated upon the switch closing the circuit.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a front view of the belt wear measurement device.

FIG. 2 is an electrical schematic of the belt wear measurement device circuit.

FIG. 3 is a perspective view of the switch.

FIG. 4 is a bottom view of the belt wear measurement device showing the switch.

FIG. 5 is a front view of the belt measurement concept for a worn belt.

FIG. 6 is a front view of the belt measurement concept for a new belt.

### DETAILED DESCRIPTION OF THE PREFERRED EMBODIMENT

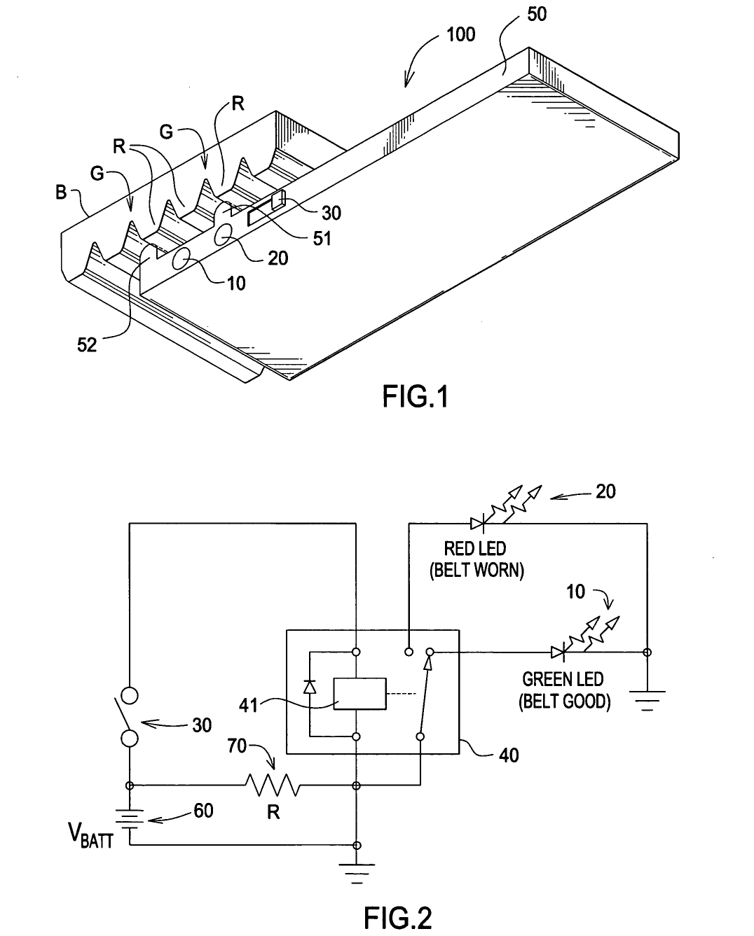

FIG. 1 is a front view of the belt wear measurement device.

The device measures belt rib wear and provides a clear indication of a worn belt through illumination of an LED. The device uses ribs to gage relative belt wear and a tactile switch/electrical circuit that functions as a worn or not worn indicator. As a belt wears, the ribs will narrow and the adjacent grooves will widen which allow the device ribs to seat or ride further “down” in the groove. The tactile switch, which relies on compression to close the circuit, will be used in combination with the belt ribs and a reference surface. The reference surface chosen is the top of the belt ribs. This is because the belt rib tips typically do not contact anything in the belt drive system and therefore, are not subjected to wear making them an ideal reference surface.

When a belt is worn to a point determined likely to increase performance related issues, the device ribs will drop far enough into the belt grooves to allow the tactile switch to be compressed. The closure of the switch will either illuminate a light or switch colors from green to red.

The belt measurement device comprises a first rib and a second rib, the first and second rib are substantially parallel, the first rib and second rib defining a predetermined engagement position for the device in a belt, and a switch cooperatively disposed with the first rib and second rib, the switch capable of closing a circuit by being compressed between a belt surface and the device, a light is illuminated upon the switch closing the circuit.

More particularly, the belt wear measurement device 100 comprises a body 50. Body 50 may comprise either a plastic or metallic material depending on the application.

Disposed on the outside of body 50 for easy of viewing by a user are a green light 10 and a red light 20. Switch 30 is mounted to the body for access by a user.

Body 50 further comprises a first rib portion 41 and a second rib portion 42. Each rib 51, 52 extend along a length of body 50. Ribs 51, 52 are parallel to each other. Ribs 51, 52 have a diameter in the range of approximately 1.3 mm to 1.6 mm. Although each portion 51, 52 is described as a “rib” for the preferred embodiment, each portion 51, 52 may also comprise any suitable arcuate or other surface such that each portion 51, 52 may engage an article feature, namely, a belt groove (G).

Each rib 51, 52 engage a groove (G) in a multi-ribbed belt (B). Each groove (G) is disposed between adjacent ribs (R).

FIG. 2 is an electrical schematic of the belt wear measurement device circuit. A tactile switch 40 known in the art is connected to on/off switch 30.

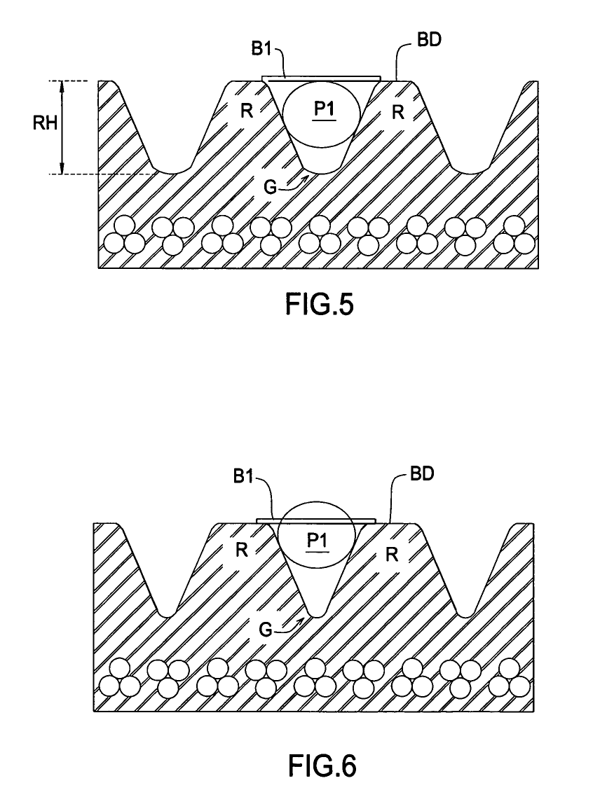

Indicator members 10, 20 are a red and green LED, respectively, known in the art. For example, Cat. No. MLED-7 for a red LED and Cat. No. MLED-8 for a green LED from All Electronics Corp. Other suitable sources are available since red and green LED's are well known in the art. Each emits a visual signal upon detection of a predetermined relationship between the article feature and the datum surface, see FIG. 5. Of course, other lights and bulbs known in the art may also be used with equal success.

A battery provides power for the device. Battery 60 may typically comprise a 12 volt “hearing aid” battery known in the art. A resister 70 has a typical value R of 1000Ω depending upon the LED selected. Other resistor values may be selected to match with the choice of LED.

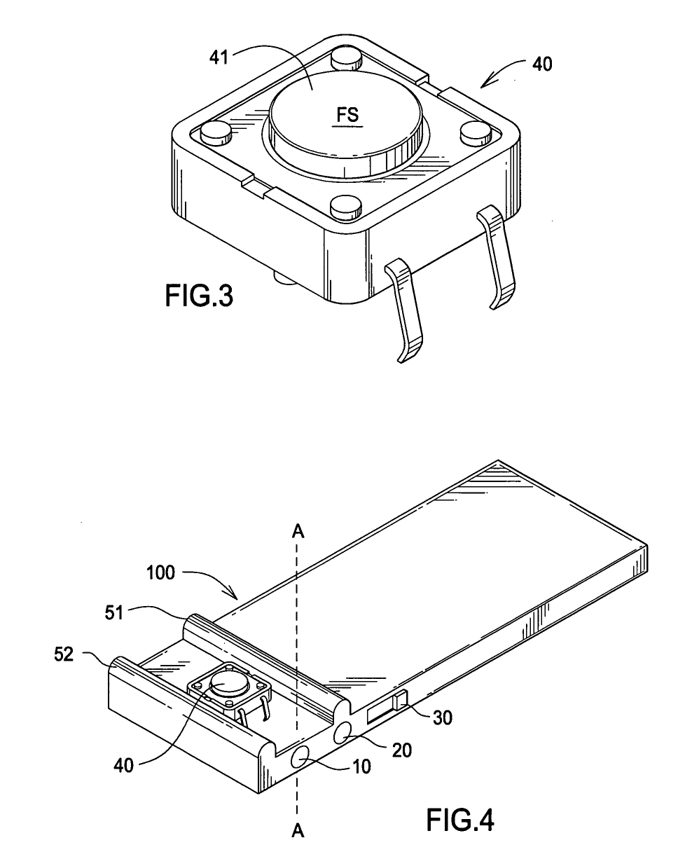

FIG. 3 is a perspective view of the switch. Switch 40 comprises a button 41. Button 41 contacts the surface of a rib (R). If the belt is worn, each rib 51, 52 will drop a predetermined distance into a groove (G). In doing so button 41 will contact a rib top surface and close the circuit, causing red LED 20 to illuminate.

The surface of button 41 defines a surface FS.

If the belt is not worn, ribs 51, 52 will not drop significantly into a groove (G) the requisite distance and button 41 will not close the circuit. In this situation the green LED 10 remains illuminated. The green LED automatically illuminates when switch 30 is closed, for example, when a user is measuring a belt.

FIG. 4 is a bottom view of the belt wear measurement device showing the switch. Switch 40 is disposed between ribs 51, 52.

FIG. 5 is a front view of the belt measurement concept for a worn belt. As a multi-ribbed belt wears the ribs become progressively narrower and the grooves become progressively wider.

Circle P1 represents the belt engaging portion of a rib 51, 52. A datum line B1 extends between the tips of each rib (R). The datum line corresponds with a top or datum surface BD of each rib R. As a belt wears the rib height RH does not significantly change, and hence the top surface BD serves as a reliable reference plane.

P1 engages a groove (G) between each rib (R). Since this is a worn belt, the full diameter of P1 is shown below datum line B1. This is because each rib (R) is worn down sufficiently so that the groove is wide enough to accommodate P1.

Since P1 rides “low” in groove (G) so will each rib 51, 52 and as a result button 41 will be compressed between device 100 and rib surface BD, thereby causing the red LED to illuminate, indicating a worn belt. The groove depth for which a red signal will be indicated can be adjusted by varying the position of plane FS for button 41 with respect to the position of ribs 51, 52 along a vertical axis A-A see FIG. 4.

FIG. 6 is a front view of the belt measurement concept for a new belt. In this view each rib (R) is new. Line B1 extends between the tips of adjacent ribs (R).

Groove (G) is relatively narrow compared to a worn belt in FIG. 5. Hence, P1 rides very much “higher” in groove (G). A significant portion of P1 extends above datum line B1.

Hence, the device detects the spatial relationship between a plane FS and a datum line B1.

The device is intended to be handheld. The user will be able to inspect belts both installed on a belt drive as well as off the drive. The device ribs are lined up with belt ribs and are then pressed into the belt grooves with the hand and fingers.

Although a form of the invention has been described herein, it will be obvious to those skilled in the art that variations may be made in the construction and relation of parts without departing from the spirit and scope of the invention described herein.

We claim:

1. A belt measurement device comprising:
a first portion and a second portion, the first and second portion are substantially parallel, the first portion and second portion define a predetermined engagement position for the device in a belt; and
a switch cooperatively disposed with the first portion and second portion, the switch capable of closing a circuit by being compressed between a belt surface and the device, a light is illuminated upon the switch closing the circuit.

2. The belt measurement device as in claim 1 further comprising a light to indicate a worn belt.

3. The belt measurement device as in claim 1 further comprising an on/off switch.

4. A measurement device comprising;
a first member having portions (51, 52) for engaging an article feature (G);
a second member (40) for detecting a datum surface (BD) when the first member is engaged with the article feature; and
an indicator member (20) which emits a visual signal upon detection of a predetermined relationship between the article feature and the datum surface.

5. The measurement device as in claim 4, wherein each portion 51, 52 comprises a rib.

6. The measurement device as in claim 4, wherein the second member comprises a switch.

7. The measurement device as in claim 4, wherein the indicator member comprises a light electrically connected to the switch.

8. The measurement device as in claim 4, wherein the article feature comprises a groove and the datum surface comprises a rib tip.
